(19) United States
(12) Patent Application Publication
(10) Pub. No.: US 2024/0313231 A1
(43) Pub. Date: Sep. 19, 2024

(54) METHOD OF MAKING PLATES WITH PURE LEAD GRIDS FOR LEAD-ACID BATTERY MANUFACTURE

(71) Applicant: Wirtz Manufacturing Company, Inc., Port Huron, MI (US)

(72) Inventors: Roel Mendoza, Palms, MI (US); Márcio Rocha, São Paulo (BR)

(21) Appl. No.: 18/426,967

(22) Filed: Jan. 30, 2024

Related U.S. Application Data
(63) Continuation of application No. 63/441,948, filed on Jan. 30, 2023.

(51) Int. Cl. H01M 4/84; B22D 11/06; C22F 1/12; H01M 4/20; H01M 4/22; H01M 4/68; H01M 4/73

(52) U.S. Cl. CPC H01M 4/84; B22D 11/0634; C22F 1/12; H01M 4/20; H01M 4/22; H01M 4/68; H01M 4/73

(57) ABSTRACT

A method of making battery plates of pure lead battery grids for lead-acid battery manufacture is presented. The method has been shown to resolve issues that have long-persisted in the battery manufacture industry involving the use of pure lead material for battery grids. According to an implementation, several processes are performed in succession in order to make pure lead battery grids feasible in commercial and mass production, among them: a continuous casting process to produce battery grids of pure lead material, a compression rolling process of the cast pure lead battery grids, and a battery paste application process to the cast and rolled pure lead battery grids. The pure lead material of the continuous strip of pure lead battery grids can consist of lead (Pb) material in an amount that ranges approximately between 99.85 percent (%) to 99.999% of the overall constituent elements of the pure lead material.

### CROSS-REFERENCE TO RELATED APPLICATION

This application claims the benefit of U.S. Provisional Patent Application No. 63/441,948, with a filing date of Jan. 30, 2023, the contents of which are hereby incorporated by reference in their entirety.

### TECHNICAL FIELD

This disclosure relates generally to lead-acid battery manufacturing processes and equipment, and, more particularly to, processes and equipment employed to manufacture battery plates and battery grids for lead-acid batteries.

### BACKGROUND

Lead-acid batteries are a common source of electrical energy and are often used as automotive batteries, marine batteries, consumer equipment batteries, small engine batteries, industrial batteries, as well as in other applications. Among their components, lead-acid batteries typically include numerous positive and negative plates that are assembled in a case and are made of metal grids with an electrochemically-active battery paste material applied on the grids. The grids serve as the current conductor or current collector of the established electrode, and the paste material serves as the active electrochemical material of the electrode. The grids are typically composed of a lead-based alloy material with additives of calcium (Ca), tin (Sn), silver (Ag), and/or aluminum (Al), as well as other possible elements. The lead-based alloy material typically has about 93.0%-99.85% of lead (Pb).

For commercial and mass production of battery plates, the grids can be produced via a continuous casting procedure, can be passed through a set of successive compression rollers, and can then be subjected to a paste application procedure, among other procedures that can be carried out. An example of a continuous casting machine is described in U.S. Pat. No. 4,415,016, assigned to Wirtz Manufacturing Company, Inc., the present applicant. An example of a rolling procedure is described in U.S. Pat. No. 5,604,058, assigned to the present applicant. And an example of a pasting machine is described in U.S. Pat. No. 4,606,383, assigned to the present applicant.

### SUMMARY

In an embodiment, a method of making battery plates of pure lead battery grids for lead-acid battery manufacture may include a multitude of steps. One step may involve continuously casting a continuous strip of pure lead battery grids in order to produce a cast continuous strip of pure lead battery grids. The cast continuous strip of pure lead battery grids is composed of a pure lead material. Another step may involve advancing the cast continuous strip of pure lead battery grids through one or more pairs of compression rollers. This step may be performed under cold-working conditions. The thickness dimension of the cast continuous strip of pure lead battery grids is reduced, and hardness is imparted to the cast continuous strip of pure lead battery grids. A cast and rolled continuous strip of pure lead battery grids is produced in this step. Yet another step may involve applying an electrochemically-active battery paste material to the cast and rolled continuous strip of pure lead battery grids.

In an embodiment, a method of making battery plates of pure lead battery grids for lead-acid battery manufacture may include a multitude of steps. One step may involve continuously casting a continuous strip of pure lead battery grids in order to produce a cast continuous strip of pure lead battery grids. The cast continuous strip of pure lead battery grids is composed of a pure lead material. The pure lead material comprises lead (Pb) in an amount of approximately 99.85 percent (%) to 99.999% of overall constituent elements of the pure lead material. Another step may involve advancing the cast continuous strip of pure lead battery grids through one or more pairs of compression rollers. This step may be performed under cold-working conditions. The thickness dimension of the cast continuous strip of pure lead battery grids is reduced, and hardness is imparted to the cast continuous strip of pure lead battery grids. The cold-working conditions involves the provision of the cast continuous strip of pure lead battery grids at a metal temperature of the grids that ranges between approximately 35 degrees Fahrenheit (° F.) to 180° F. prior to advancing the cast continuous strip of pure lead battery grids through the at least one pair of compression rollers. Yet another step may involve applying an electrochemically-active battery paste material to the cast and rolled continuous strip of pure lead battery grids.

In an embodiment, a method of making battery plates of pure lead battery grids for lead-acid battery manufacture may include a multitude of steps. One step may involve continuously casting a continuous strip of pure lead battery grids in order to produce a cast continuous strip of pure lead battery grids. The cast continuous strip of pure lead battery grids is composed of a pure lead material. The pure lead material comprises lead (Pb) in an amount of approximately 99.85 percent (%) to 99.999% of overall constituent elements of the pure lead material. Another step may involve advancing the cast continuous strip of pure lead battery grids through one or more pairs of compression rollers. This step may be performed under cold-working conditions. The thickness dimension of the cast continuous strip of pure lead battery grids is reduced, and hardness is imparted to the cast continuous strip of pure lead battery grids. The cold-working conditions involves the provision of the cast continuous strip of pure lead battery grids at a metal temperature of the grids that ranges between approximately 35 degrees Fahrenheit (° F.) to 180° F. prior to advancing the cast continuous strip of pure lead battery grids through the at least one pair of compression rollers. The reduction in thickness amid compression rolling involves reducing a cross-sectional thickness dimension of the cast continuous strip of pure lead battery grids by approximately 1 percent (%) to 70% of an original cross-sectional thickness dimension of the cast continuous strip of pure lead battery grids. Yet another step may involve applying an electrochemically-active battery paste material to the cast and rolled continuous strip of pure lead battery grids.

### BRIEF DESCRIPTION OF THE DRAWINGS

Certain embodiments of the disclosure are described with reference to the appended drawings, in which:

FIG. 1 is a flow chart of an embodiment of a method of making battery plates of pure lead battery grids for lead-acid battery manufacture;

FIG. 2 is a side view of an example of a battery grid continuous casting machine;

FIG. 3 is a front view of the battery grid continuous casting machine;

FIG. 4 shows an example of a strip or web of continuously cast battery grids;

FIG. 5 is a schematic depiction of an example of a compression rolling process; and

FIG. 6 shows an example of a battery paste application machine.

### DETAILED DESCRIPTION

With reference to the figures, an embodiment of a method of making battery plates of pure lead battery grids for lead-acid battery manufacture is presented. The method has been shown to resolve issues that have long-persisted in the battery manufacture industry involving the use of pure lead material for battery grids. According to this embodiment of the method, several processes are performed in succession in order to make pure lead battery grids feasible in commercial and mass production, among them: a continuous casting process to produce battery grids of pure lead material, a compression rolling process of the cast pure lead battery grids, and a battery paste application process to the cast and rolled pure lead battery grids. By subjecting the cast pure lead battery grids to the compression rolling process downstream of the continuous casting process, it has been determined that the cast and rolled pure lead battery grids are hardened to a degree exhibiting enhanced dimensional stability. Unlike past efforts, the cast and rolled pure lead battery grids can subsequently be handled and manipulated by machines and equipment especially battery paste application machines without unintended and unwanted deformation and stretching of the grids that imperiled dimensionality of past grids. Deformation and stretching is minimized or altogether averted by the method. Also, material waste and recycling thereof can be altogether avoided with use of the method, since punching and/or cutting extraneous material portions need not necessarily be performed according to the method. A more effective and efficient method of making pure lead battery grids is hence furnished, rendering commercial and mass production feasible. Moreover, lead-acid batteries equipped with the pure lead battery grids of the method herein have been shown to endure life cycle testing that is twofold previous lead-acid batteries with lead-alloy grids. Lastly, the method of making battery plates of pure lead battery grids can be employed in a larger manufacturing setup and process that produces lead-acid batteries for automotive applications, marine applications, consumer equipment applications, small engine applications, and industrial applications, among many other possibilities. Furthermore, as used herein, the terms upstream and downstream refer to directions with respect to the general and intended aggregate movement of grid processing from casting to paste application amid their manufacture.

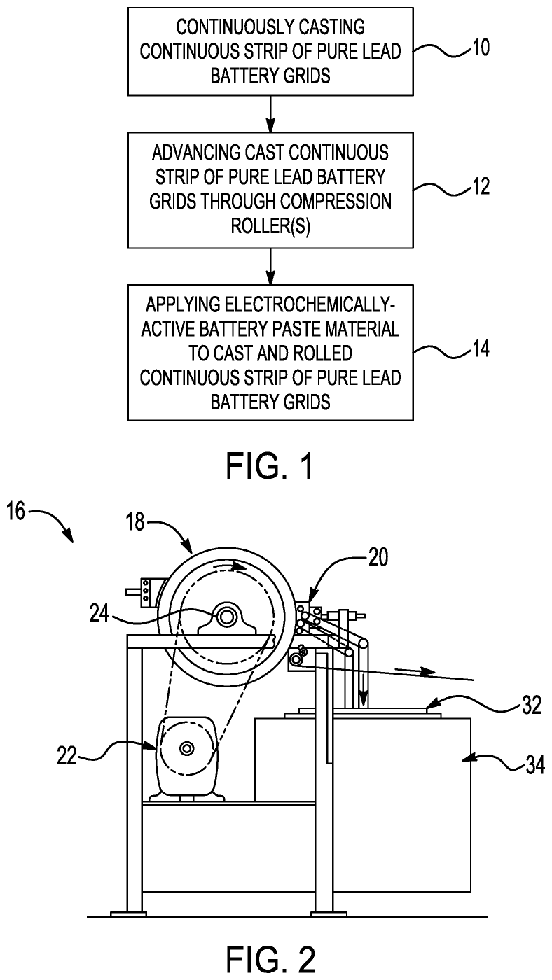

The method of making battery plates of pure lead battery grids for lead-acid battery manufacture can include various steps according to various embodiments. According to the embodiment of FIG. 1, the method includes the steps: a first step 10 of continuously casting a continuous strip of pure lead battery grids, a second step 12 of advancing the cast continuous strip of pure lead battery grids through one or more pairs of compression rollers, and a third step 14 of applying an electrochemically-active battery paste material to the cast and rolled continuous strip of pure lead battery grids. The first, second, and third steps 10, 12, 14 can be carried out in succession, one after another. Still, the method of making battery plates of pure lead battery grids can involve more, less, and/or different steps in other embodiments; for instance, after the second step 12 of compression rolling and before the third step 14 of battery paste application, the cast and rolled continuous strip of pure lead battery grids could be wound and coiled into a spool for transport to the location of the battery paste application; and after the third step of battery paste application, the continuous strip of pure lead battery grids can undergo a severing step in which the strip is cut into multiple individual pasted pure lead battery grids for subsequent stacking and deployment in lead-acid batteries.

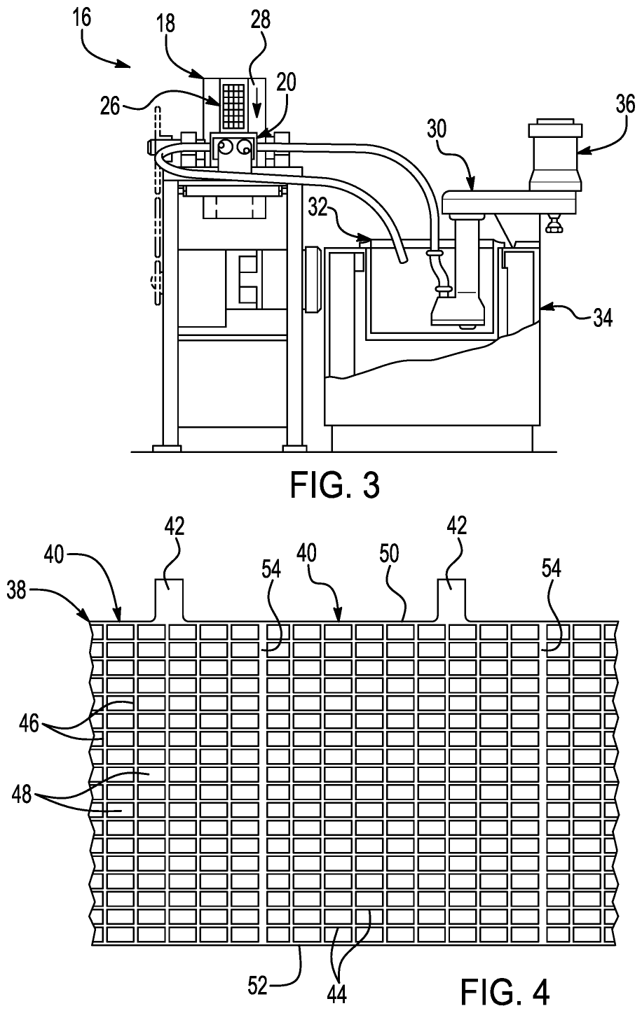

The first step 10 of continuously casting the continuous strip of pure lead battery grids can involve various procedures and equipment and machines to perform the continuously casting process. One example is disclosed in U.S. Pat. No. 11,253,914, assigned to the present assignee, and the contents of which are hereby incorporated herein in their entirety by reference. In the present patent, an example of a battery grid continuous casting machine 16 is shown in FIGS. 2 and 3. The casting machine 16 includes, as its primary components, a casting drum 18 and a shoe 20. The casting drum 18 is driven to rotate by an electric motor 22 (e.g., variable speed electric motor) about a bearing assembly 24. A mold cavity 26 resides in a cylindrical outer surface 28 of the casting drum 18. The mold cavity 26 exhibits a predetermined battery grid pattern. Pure lead in a molten state is supplied via the shoe 20 and to a confronting section of the mold cavity 26 of the casting drum 18 amid rotation. The molten pure lead is received in the mold cavity 26 and, upon its solidification, produces the cast continuous strip of pure lead battery grids. A pump 30 supplies the molten pure lead at a super atmospheric pressure from a melting pot 32 of a furnace 34 and to the shoe 20. An electric motor 36 (e.g., variable speed electric motor) can drive the pump 30. Alteration of the super atmospheric pressure and/or flow rate of the molten pure lead is effected via the electric motor 36 and pump 30. Excess molten pure lead may be returned from the shoe 20 to the melting pot 32. Still, other kinds and types of casting equipment and machines could be employed in other embodiments.

With reference now to FIG. 4, an example of an as-cast continuous strip of pure lead battery grids 38 or elongated web is depicted. The strip of grids 38 includes multiple individual battery grids 40 that are connected together at this stage of processing, but are ultimately severed and separated prior to installation in a lead-acid battery. Waste material is not yielded by this severing and separation, unlike other processes. The grids 40 are typically flat, planar, and thin, and designed and constructed per parameters of the lead-acid battery in which they are installed. The grids 40 can be utilized for a positive plate (i.e., cathode) and a negative plate (i.e., anode) of an assembled lead-acid battery. In the example of FIG. 4, the strip of grids 38 includes connector lugs 42 provided for each grid 40. The strip of grids 38 and each individual grid 40, per this example, has a multitude of horizontally-extending grid wires 44 and a multitude of vertically-extending grid wires 46 in a crisscrossing arrangement. The grid wires 44, 46 intersect one another at nodes, and open and empty spaces 48 reside among the grid wires 44, 46. A top frame wire 50 and a bottom frame wire 52 bound the associated extents of the strip of grids 38 and each individual grid 40, and side frame wires 54 bound sides of each grid 40. Still, the continuous strip of pure lead battery grids could have other designs, constructions, and arrangements in other examples; for instance, two sets of continuous strips connected in parallel could be cast concurrently, and/or the grid wires could have other patterns such as an angular zig-zag pattern. Such alternatives will be appreciated by skilled artisans.

As described, once cast and solidified, the continuous strip of pure lead battery grids 38 is wholly composed of a pure lead material. Its entire construction is made of pure lead material, including the connector lugs 42, grid wires 44, 46, top frame wire 50, bottom frame wire 52, and side frame wires 54. The pure lead material is composed of substantially all lead (Pb) material, with certain additive constituent elements in order to alter certain properties of the continuous strip of pure lead battery grids 38, as desired for a particular embodiment and application. In one example embodiment, the pure lead material of the continuous strip of pure lead battery grids 38 consists of lead (Pb) material in an amount that ranges approximately between 99.85 percent (%) to 99.999% of the overall constituent elements of the pure lead material, or consists of lead (Pb) material in an amount that ranges approximately between 99.9 percent (%) to 99.999% of the overall constituent elements of the pure lead material, or consists of approximately 99.85% lead (Pb) material overall, or consists of approximately 99.9% lead (Pb) material overall, or consists of approximately 99.999% lead (Pb) material overall. The precise additive constituent elements and their concentrations in the pure lead material may vary according to different embodiments. The table presented below sets forth some exemplary embodiments of pure lead materials and concentrations of additive constituent elements. The balance of the pure lead materials, as described, is lead (Pb) material (e.g., 99.85% to 99.9%, or 99.85% to 99.999%, or 99.9% to 99.999%). Not all of the additive constituent elements in the table need be included in a particular embodiment of the pure lead material, and rather a combination of the additive constituent elements can compose the pure lead material of the continuous strip of pure lead battery grids 38 according to various embodiments. The minimum and maximum values in the table are meant to denote lower and upper bounds of ranges of the particular additive constituent element. For instance, the pure lead material can have the constituent element calcium (Ca) in an amount that ranges approximately between 0.0002% and 0.045%, or from approximately two parts per million (PPM) to approximately 450 PPM, according to an embodiment.

TABLE
Exemplary Embodiments of Pure Lead Materials
and Concentrations of Constituent Elements
Pure Lead Material

| | Concentration of Constituent Elements | | | |
|---|---|---|---|---|
| | Minimum | | Maximum | |
| | Percent (%) | PPM | Percent (%) | PPM |
| Calcium (Ca) | 0.0002 | 2 | 0.045 | 450 |
| Aluminum (Al) | 0.0002 | 2 | 0.01 | 100 |
| Tin (Sn) | 0.005 | 50 | 0.5 | 5000 |
| Barium (Ba) | 0.0002 | 2 | 0.045 | 450 |
| Antimony (Sb) | 0.0002 | 2 | 0.045 | 450 |
| Selenium (Se) | 0.0002 | 2 | 0.045 | 450 |
| Arsenic (As) | 0.0002 | 2 | 0.045 | 450 |
| Tellurium (Te) | 0.0002 | 2 | 0.045 | 450 |
| Copper (Cu) | 0.0002 | 2 | 0.045 | 450 |
| Iron (Fe) | 0.0002 | 2 | 0.045 | 450 |
| Molybdenum (Mo) | 0.0002 | 2 | 0.045 | 450 |

Use of pure lead material for battery grids for lead-acid battery manufacture has been deemed impractical for commercial and mass production operations and machines and equipment. Cast pure lead battery grids have previously proven too soft and flimsy for downstream equipment handling and manipulation, especially at battery paste application machines. Cast pure lead battery grids of the past have been prone to deformation and stretching post-casting in unintended and unwanted ways, making them impractical for commercial and mass production operations and dissuading their utilization altogether. Certain cast pure lead battery grids of the past have exhibited dimensional instability. It has been a persistent industry problem.

The method of making battery plates of pure lead battery grids, as set forth in this patent, has been found to resolve the shortcomings of the past. By processing the continuous strip of pure lead battery grids 38 at the second step 12 of advancing the strip of grids 38 through the compression roller(s) downstream of the first step 10 and upstream of the third step 14, it has been determined that the resulting cast and rolled pure lead battery grids are hardened to a suitable degree of enhanced dimensional stability. After the second step 12, the cast and rolled pure lead battery grids have been found to be readily handled and manipulated by downstream machines and equipment—such as by battery paste application machines, like that of the third step 14 described below—without the unintended and unwanted deformation and stretching experienced by the grids of the past. All in all, commercial and mass production operations are facilitated by, and more readily feasible and practical with, the method of making battery plates of pure lead battery grids as set forth herein.

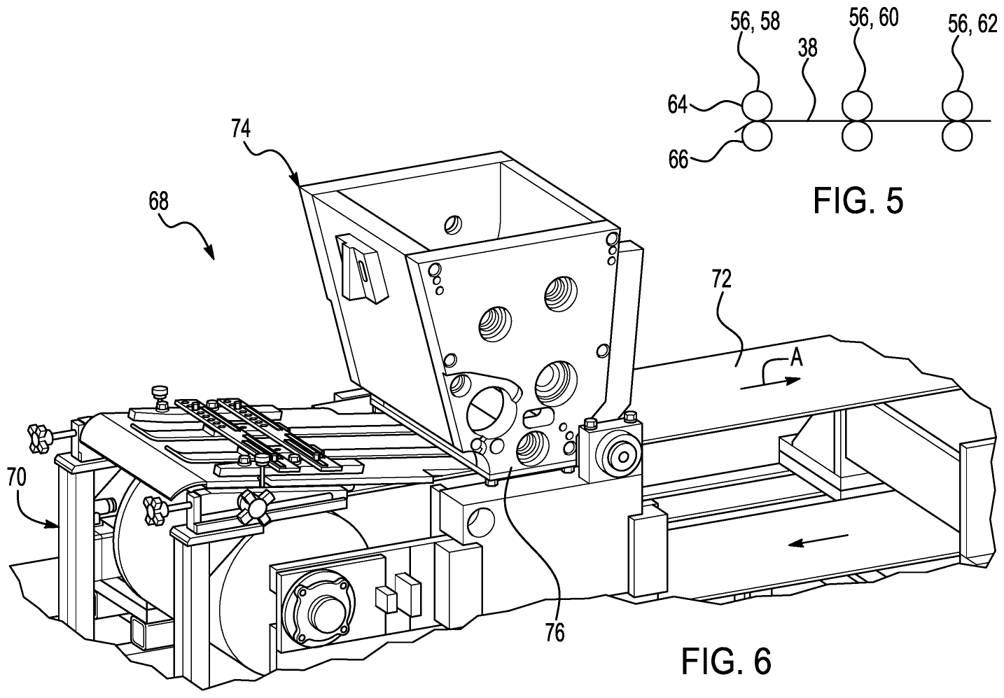

The second step 12 of advancing the cast continuous strip of pure lead battery grids 38 through the compression roller(s) can involve various procedures and equipment and machines for performing the rolling process. One example is disclosed in U.S. Pat. No. 5,604,058, assigned to the present assignee, and the contents of which are hereby incorporated herein in their entirety by reference. In the present patent, an example of a series of successive compression rollers 56 is shown in FIG. 5. The compression rollers 56 are three sets in total in the figure, but could be more or less in number in other embodiments. A first set of compression rollers 58 initially receives the strip of grids 38, followed by a second set of compression rollers 60 and then a third set of compression rollers 62, as the strip of grids 38 progressively travels therethrough (left-to-right in the figure). The strip of grids 38 is received through a nip, or clearance, that resides between an upper roller 64 and a lower roller 66 of each of the first, second, and third sets of compression rollers 58, 60, 62. Each set of compression rollers 58, 60, 62 can be part of a larger compression roller machine that can also include an electric motor (e.g., variable speed electric motor) and gearset for driving rotation of the upper and lower rollers 64, 66, carrier blocks, roller shafts, and a frame, among many other possible components; still, other examples of compression roller machines could have components of varying kinds and types.

Each set of compression rollers 58, 60, 62 can serve to reduce a cross-sectional thickness dimension of the strip of grids 38 to a greater extent, and each set can harden the strip of grids 38 to a greater degree. In an example, the cross-sectional thickness dimension of the strip of grids 38 is reduced progressively from approximately 1% to 70% from the initial set of compression rollers (e.g., first set of compression rollers 58) to the final set of compression rollers (e.g., third set of compression rollers 62) with respect to an original cross-sectional thickness dimension prior to the rolling process and after the continuously casting process; still, other cross-sectional thickness dimensions and reductions may be possible in other examples. It has been found that such reductions in thickness dimension facilitates utilization of pure lead material for battery grids. Further, in an example, the hardness of the strip of grids 38 is increased sufficiently for subsequent handling and manipulation from the initial set of compression rollers and to the final set of compression rollers. Moreover, an overall size (e.g., length, width) of the strip of grids 38 can be elongated as the strip of grids 38 passes through the compression rollers. In an example, the overall size of the strip of grids 38 increases from approximately 1% to 30% from the initial set of compression rollers and to the final set of compression rollers with respect to an original overall size prior to the rolling process and after the continuously casting process; still, other size increases may be possible in other examples. The rolling process can be carried out under cold-working conditions. Example cold-working conditions involve metal temperatures of the strip of grids 38 being in a range of approximately 35 degrees Fahrenheit (° F.) to 180° F., or in a range of approximately 50° F. to 80° F.; still, other temperatures may be possible in other examples. It has been found that such cold-working temperatures facilitate utilization of pure lead material for battery grids. In order to bring the temperatures of the strip of grids 38 down to these cold-working temperatures after the first step 10 of continuous casting, the strip of grids 38 are 170° F. before the second step 12 is carried out. The rolling process can be performed directly and promptly downstream of the first step 10 of continuous casting, and in the absence of winding and coiling immediately after casting; winding and coiling immediately post-casting has been shown to deform and stretch the strip of grids 38. Rather, winding and coiling of the strip of grids 38 can be performed immediately downstream of the second step 12 of rolling.

During certain casting processes, surfaces of the casting equipment (e.g., casting machine 16) can be coated with one or more lubricants, coolants, and/or other substances. It has been found that, in certain circumstances, such substances may exhibit a tendency to physically and chemically interact with hot pure lead material, such as that of the continuous strip of pure lead battery grids 38. When the substances are not fully removed from surfaces of the strip of grids 38, it has been shown, good surface-to-surface contact and adherence with a subsequently-applied battery paste material such as at the third step 14 may be hindered or altogether precluded. Accordingly, the method of making battery plates of pure lead battery grids can include a step of treating surfaces of the strip of grids 38. This surface treatment can be carried out downstream and after the first step 10 of continuous casting, and downstream and after the second step 12 of rolling. Treating the surfaces cleans the strip of grids 38 and fully removes the undesired substances from the surfaces of the strip of grids 38. The surface treatment has also been shown to pre-corrode the surfaces of the strip of grids 38. Enhanced surface-to-surface contact and adherence of battery paste material with the strip of grids 38 is hence more readily enabled.

The step of treating the surfaces of the strip of grids 38 can take different forms in different embodiments. According to an example, steam or water vapor is brought into contact with the surfaces of the strip of grids 38. The strip of grids 38 can be moved into a steam chamber where steam is furnished and contained. Within the steam chamber, per this example, temperatures of the steam range approximately between 40 degrees Celsius (° C.) and 60° C., and the strip of grids 38 remains within the steam chamber for a duration of approximately 2 seconds to 30 seconds in total; still, other temperatures and durations may be possible in other examples. Moreover, it has been determined that higher steam temperatures may work to anneal the pure lead material of the strip of grids 38, making the pure lead material softer as a consequence, and potentially causing the strip of grids 38 to again be prone to deformation and stretching—temperatures between 80° C. and 120° C., in particular, have proven too high in this regard.

Furthermore, as an alternative to steam, in another example the surfaces of the strip of grids 38 are brought into contact with an aqueous solution of hydrogen peroxide (H₂O₂). The strip of grids 38 can be continually drawn through a contained bath of the aqueous solution of hydrogen peroxide. Per an example, the aqueous solution consists of 3% concentration of hydrogen peroxide in water (which equals 10 volumes) to 70% concentration of hydrogen peroxide in water (which equals 260 volumes). The temperature of the aqueous solution of hydrogen peroxide can range approximately between 25° C. and 60° C., and the strip of grids 38 can remain submerged and in contact with the aqueous solution of hydrogen peroxide for a duration ranging approximately between several seconds to one minute.

The third step 14 of applying the electrochemically-active battery paste material to the cast and rolled continuous strip of pure lead battery grids 38 can involve various procedures and equipment and machines. One example is disclosed in U.S. Pat. No. 9,437,867, assigned to the present assignee, and the contents of which are hereby incorporated herein in their entirety by reference. In the present patent, an example of a battery paste application machine 68 is shown in FIG. 6. The battery paste application machine 68 includes, as its primary components, a frame 70, a belt 72, and a hopper 74. The belt 72 carries the strip of grids 38 through the battery paste application machine 68 underneath the hopper 74, and is typically driven by an electric motor and one or more rollers. The hopper 74 holds battery paste material and dispenses it onto the strip of grids 38 as the grids pass beneath the hopper 74 amid use of the battery paste application machine 68. Further, to keep the battery paste material in a mixed state for ready dispensation, multiple internal feed rollers and paddles can be mounted at an interior of the hopper 74 and submerged within the battery paste material. An orifice plate 76 is mounted to a bottom end of the hopper 74 and, with the exception of an orifice slot residing in the plate, generally closes the bottom end. Battery paste material is fed through the orifice slot from the hopper's interior and to the strip of grids 38 passing beneath the hopper 74.

Life cycle battery testing was performed on lead-acid batteries equipped with pure lead battery grids such as those of the continuous strip of pure lead battery grids 38. The pure lead battery grids were composed of pure lead material, as described herein, and were made by processes similar to the first step 10 of continuously casting the continuous strip of pure lead battery grids and by processes similar to the second step 12 of advancing the cast continuous strip of pure lead battery grids through the compression rollers 56, as described herein. Battery paste material was applied to the cast and rolled strip of grids subject to testing. The life cycle battery testing involved simulated testing intended to evaluate the cycle life and longevity of the lead-acid batteries. The life cycle battery testing conducted was the industry standard testing procedure, sometimes referred to as Hot J240C 75 degC. Testing parameters included charge and discharge cycles with a current of 25 amps and at a temperature of 75° C. Previous life cycle battery testing for past lead-acid batteries with lead-alloy battery grids yielded results of up to 3,000 total cycles of longevity. While considered suitable under most circumstances, life cycle battery testing for lead-acid batteries equipped with pure lead battery grids as described herein yielded results of up to 6,000 total cycles of longevity, a twofold improvement relative to the past results.

As used herein, the terms “general,” “generally,” “approximately,” and “substantially” are intended to account for the inherent degree of variance and imprecision that is often attributed to, and often accompanies, any design and manufacturing process and measurement, including engineering tolerances, and without deviation from the relevant functionality and intended outcome, such that mathematical precision and exactitude is not implied and, in some instances, is not possible.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of making battery plates of pure lead battery grids for lead-acid battery manufacture, the method comprising:
continuously casting a continuous strip of pure lead battery grids to produce a cast continuous strip of pure lead battery grids, the cast continuous strip of pure lead battery grids composed of a pure lead material;
advancing the cast continuous strip of pure lead battery grids through at least one pair of compression rollers under cold-working conditions in order to reduce a thickness dimension of the cast continuous strip of pure lead battery grids and to impart hardness to the cast continuous strip of pure lead battery grids, producing a cast and rolled continuous strip of pure lead battery grids; and
applying an electrochemically-active battery paste material to the cast and rolled continuous strip of pure lead battery grids.

2. The method of making battery plates of pure lead battery grids as set forth in claim 1, wherein the pure lead material of the pure lead battery grids comprises lead (Pb) in an amount of approximately 99.85 percent (%) to 99.999% of overall constituent elements of the pure lead material.

3. The method of making battery plates of pure lead battery grids as set forth in claim 2, wherein the pure lead material of the pure lead battery grids comprises calcium (Ca) in an amount of approximately 0.0 percent (%) to 0.045% of the overall constituent elements of the pure lead material.

4. The method of making battery plates of pure lead battery grids as set forth in claim 1, wherein the pure lead material of the pure lead battery grids comprises lead (Pb) in an amount of approximately 99.85 percent (%) to 99.999% and calcium (Ca) in an amount less than (<) approximately 0.045% of overall constituent elements of the pure lead material.

5. The method of making battery plates of pure lead battery grids as set forth in claim 1, wherein applying the electrochemically-active battery paste material involves use of a belt-and-hopper battery paste application machine.

6. The method of making battery plates of pure lead battery grids as set forth in claim 1, further comprising treating surfaces of the cast and rolled continuous strip of pure lead battery grids with water vapor prior to applying the electrochemically-active battery paste material.

7. The method of making battery plates of pure lead battery grids as set forth in claim 6, wherein treating surfaces of the cast and rolled continuous strip of pure lead battery grids with water vapor involves providing the water vapor at a temperature ranging approximately between approximately 40 to 60 degrees Celsius (° C.).

8. The method of making battery plates of pure lead battery grids as set forth in claim 1, further comprising contacting surfaces of the cast and rolled continuous strip of pure lead battery grids with an aqueous solution consisting essentially of hydrogen peroxide in water prior to applying the electrochemically-active battery paste material.

9. The method of making battery plates of pure lead battery grids as set forth in claim 1, wherein advancing the cast continuous strip of pure lead battery grids through the at least one pair of compression rollers under cold-working conditions comprises providing the cast continuous strip of pure lead battery grids at a metal temperature thereof that ranges between approximately 35 degrees Fahrenheit (° F.) to 180° F. prior to advancing the cast continuous strip of pure lead battery grids through the at least one pair of compression rollers.

10. The method of making battery plates of pure lead battery grids as set forth in claim 1, wherein advancing the cast continuous strip of pure lead battery grids through the at least one pair of compression rollers under cold-working conditions comprises providing the cast continuous strip of pure lead battery grids at a metal temperature thereof that ranges between approximately 50 degrees Fahrenheit (° F.) to 80° F. prior to advancing the cast continuous strip of pure lead battery grids through the at least one pair of compression rollers.

11. The method of making battery plates of pure lead battery grids as set forth in claim 1, wherein advancing the cast continuous strip of pure lead battery grids through the at least one pair of compression rollers under cold-working conditions comprises reducing a cross-sectional thickness dimension of the cast continuous strip of pure lead battery grids by approximately 1 percent (%) to 70% of an original cross-sectional thickness dimension of the cast continuous strip of pure lead battery grids.

12. A method of making battery plates of pure lead battery grids for lead-acid battery manufacture, the method comprising:
continuously casting a continuous strip of pure lead battery grids to produce a cast continuous strip of pure lead battery grids, the cast continuous strip of pure lead battery grids composed of a pure lead material, the pure lead material comprising lead (Pb) in an amount of approximately 99.85 percent (%) to 99.999% of overall constituent elements of the pure lead material;
advancing the cast continuous strip of pure lead battery grids through at least one pair of compression rollers under cold-working conditions in order to reduce a thickness dimension of the cast continuous strip of pure lead battery grids and to impart hardness to the cast continuous strip of pure lead battery grids, producing a cast and rolled continuous strip of pure lead battery grids, wherein the cold-working conditions involves providing the cast continuous strip of pure lead battery grids at a metal temperature thereof that ranges between approximately 35 degrees Fahrenheit (° F.) to 180° F. prior to advancing the cast continuous strip of pure lead battery grids through the at least one pair of compression rollers; and
applying an electrochemically-active battery paste material to the cast and rolled continuous strip of pure lead battery grids.

13. The method of making battery plates of pure lead battery grids as set forth in claim 12, wherein advancing the cast continuous strip of pure lead battery grids through the at least one pair of compression rollers under cold-working conditions comprises reducing a cross-sectional thickness dimension of the cast continuous strip of pure lead battery grids by approximately 1 percent (%) to 70% of an original cross-sectional thickness dimension of the cast continuous strip of pure lead battery grids.

14. The method of making battery plates of pure lead battery grids as set forth in claim 13, further comprising treating surfaces of the cast and rolled continuous strip of pure lead battery grids with water vapor prior to applying the electrochemically-active battery paste material.

15. The method of making battery plates of pure lead battery grids as set forth in claim 13, further comprising contacting surfaces of the cast and rolled continuous strip of pure lead battery grids with an aqueous solution consisting essentially of hydrogen peroxide in water prior to applying the electrochemically-active battery paste material.

16. A method of making battery plates of pure lead battery grids for lead-acid battery manufacture, the method comprising:
continuously casting a continuous strip of pure lead battery grids to produce a cast continuous strip of pure lead battery grids, the cast continuous strip of pure lead battery grids composed of a pure lead material, the pure lead material comprising lead (Pb) in an amount of approximately 99.85 percent (%) to 99.999% of overall constituent elements of the pure lead material;
advancing the cast continuous strip of pure lead battery grids through at least one pair of compression rollers under cold-working conditions in order to reduce a thickness dimension of the cast continuous strip of pure lead battery grids and to impart hardness to the cast continuous strip of pure lead battery grids, producing a cast and rolled continuous strip of pure lead battery grids, wherein the cold-working conditions involves providing the cast continuous strip of pure lead battery grids at a metal temperature thereof that ranges between approximately 35 degrees Fahrenheit (° F.) to 180° F. prior to advancing the cast continuous strip of pure lead battery grids through the at least one pair of compression rollers, and wherein reducing the thickness dimension involves reducing a cross-sectional thickness dimension of the cast continuous strip of pure lead battery grids by approximately 1 percent (%) to 70% of an original cross-sectional thickness dimension of the cast continuous strip of pure lead battery grids; and
applying an electrochemically-active battery paste material to the cast and rolled continuous strip of pure lead battery grids.

17. The method of making battery plates of pure lead battery grids as set forth in claim 16, further comprising contacting surfaces of the cast and rolled continuous strip of pure lead battery grids with an aqueous solution consisting essentially of hydrogen peroxide in water prior to applying the electrochemically-active battery paste material.

18. The method of making battery plates of pure lead battery grids as set forth in claim 16, further comprising treating surfaces of the cast and rolled continuous strip of pure lead battery grids with water vapor prior to applying the electrochemically-active battery paste material.
